(19) United States
(12) Patent Application Publication
(10) Pub. No.: US 2024/0062284 A1
(43) Pub. Date: Feb. 22, 2024

(54) MODULE FOR REALIZING PRECIOUS METALS AND A METHOD FOR SELLING PRECIOUS METALS BY MEANS OF THE MODULE

(71) Applicants: Serhii Yevhenovych Monashov, Kyiv (UA); Myroslav Illych Yakibchuk, Kyiv (UA); Fred M Mosely, Solon, OH (US); Mykhailo Viktorovych Panov, Volnovaha (UA)

(72) Inventors: Serhii Yevhenovych Monashov, Kyiv (UA); Myroslav Illych Yakibchuk, Kyiv (UA); Fred M Mosely, Solon, OH (US); Mykhailo Viktorovych Panov, Volnovaha (UA)

(21) Appl. No.: 18/046,669

(22) Filed: Oct. 14, 2022

(30) Foreign Application Priority Data
Aug. 19, 2022 (UA) A 2022 03018

(51) Int. Cl. G06Q 40/02; G06Q 20/40

(52) U.S. Cl. CPC G06Q 40/02; G06Q 20/40

(57) ABSTRACT

A group of inventions relates to a field of use of communication information technologies in a financial activity and discloses a provision of a separate module for realizing precious metal bars that is an OEM-component and that may be used to equip self-service apparatuses, while at the same time integrated into a plurality of banking or financial systems, and to a method for realizing by means of said module. Implementation of the invention enables to automatically provide wide opportunities to select both a provider of a service for selling precious metal bars and to pay for their purchase in any acceptable way.

### CROSS-REFERENCE TO RELATED APPLICATION

This application claims priority to Ukrainian Application No. a 2022 03018, filed Aug. 19, 2022, which is hereby incorporated by reference in its entirety.

### FIELD OF THE INVENTION

A group of inventions relates to a field of use of communication information technologies in a financial activity, namely, to an automated module in a system for providing financial and/or banking services for realizing precious metals, in particular, gold, in order to allow selling certified bars by executing financial transactions, and to a method for selling by means of said module.

### PRIOR ART

Automated systems and methods for realizing precious metals via ATMs, vending machines or other hardware self-service means, which are known from a prior art, imply that such service is provided only in case a user possesses gold assets in financial and/or banking institutions. That is, it is allowed to purchase a physical equivalent of the precious metal remotely only as an exchange under a proviso that a client possesses a documented right for such exchange that is certified, e.g., by a bar holder card or by a confirmed availability of corresponding tokens in a virtual space.

For example, a pat. KR102302945 teaches a gold wealth management system that enables to purchase gold bards by interaction with a gold bar vending machine, where multiple gold bars are stored, based on digital gold tokens, and an operation method thereof. This invention relates to a gold wealth management server that helps a gold possessor to purchase gold bars, which are sold in a specific gold bar selling machine, using the gold which they possess virtually, and to a method for operation thereof. Drawbacks of this solution are that the selling of a precious metal is linked to a specific vending machine that is equipped with this server, as well as that each gold bar corresponds to the token and, according to this transaction extension, a transaction identification, authentication and verification procedure using an encryption of data exchange with the server.

Another example of realizing banking precious metals via self-service devices is described in a pat. U.S. Ser. No. 11/087,307B2 that teaches a system and an associated method for providing a cash exchange service in various international denominations for goods such as precious metals (e.g., gold, silver etc.) by creating a cloud platform that enables participants to transfer, to receive or to otherwise exchange fiat money for a precious metal by generating a code based on a mobile phone number. The system is capable of delivering the cash between two or more users, thereby enabling to exchange safe transactions between the system and ATMs which are equipped with precious metal dispensers. This solution eliminates a linkage between the purchase and virtual gold assets and resolves a problem of a transactional purchase, however, it requires a confirmation that devices which are connected to the cloud platform are physically equipped with a corresponding banking bar dispensing module. That is, a drawback of said system lies in that the method for exchanging the cash for the precious metal is not a direct transaction in place, but it comprises preliminary creating an account and generating a code that may be realized afterwards, if a device is present, the device being specifically equipped both with a hardware means for realization of the precious metal and a software means for reading this code. Furthermore, this solution does not enable to purchase using payment means other than the cash payment, and the solution does not enable to purchase the precious metal in place upon making any transaction, rather than only cash transaction.

### SUMMARY OF THE INVENTION

A task of the present invention is to provide a separate module for selling precious metal bars that is an OEM-component and that may be used for equipping self-service apparatuses, while at the same time being integrated into a plurality of banking or financial systems. To this end, it must be equipped with a hardware part and a software part which are adapted to be mounted within any self-service apparatus being an ATM, a dispensing system at a bank branch, a vending machine etc., while providing its network communication with a system that provides a wide range of financial and/or banking services within a single interface window from all connected providers of financial and/or banking services providers with corresponding services. A technical effect to be achieved upon resolution of said task lies in providing a simple and a reliable use of the module that enables a user, in a fully automatic mode at a single location, to implement wide opportunities of both selecting a provider of this service and paying for a purchase of precious metal bars in any acceptable way being a cash payment, a cashless payment or using digital assets, and without steps of generating random codes and without involvement of additional means.

Said effect is achieved owing to a precious metal realization module which comprises hardware and software elements which are connected between each other and to an omnichannel system for providing financial and/or banking services. Said module comprises a hardware unit C that is equipped with a dispenser for storing and dispensing certified bars, the dispenser stores a plurality of gold bars of at least two weight types of from 1 g to 1 ounce. This unit may be physically connected to any self-service apparatus that is integrated with the omnichannel system for providing financial and/or banking services. Therewith, the omnichannel system for providing financial and/or banking services comprises a client automatic identification means connected to databases of providers of financial and/or banking services and a unified integration platform for connecting to at least two providers of financial and/or banking services so as to enable selecting and activating those from them which are authorized to sell the precious metal.

The module further comprises a first software unit A that has an embedded MDB-supporting data bus Plug&Play to implement the connection of the hardware unit C to the self-service device, and a second software unit B to provide the interaction, via a REST API protocol, between the self-service device and the omnichannel system that is equipped with the unified integration platform, thereby providing a service channel for selling the precious metal via an ISO 8583 protocol with a processing center of the provider of financial and/or banking services and the user by sending requests to automated banking systems (ABS) of the providers of financial and/or banking services via a secured communication channel or via an API protocol.

The interaction between the software units A and B and the hardware unit C is provided by a third software unit D having a monolithic kernel that comprises components which are configured to execute a financial transaction from a selected payment source. All parts of the monolithic kernel of the unit D operate within a single address space. This scheme is implemented owing to the fact that all components of its kernel are constituent parts of the single software program and utilize general data structures and interact between each other by calling procedures directly, and each of them may call for another one. All procedures operate in a privileged mode.

In a second aspect, the present invention provides a method for providing a user with a service of purchasing precious metal bars, the method comprises following required steps of interaction between elements of the module for realizing precious metals.

A step of requesting for a presence of a certified bar within the dispenser of the hardware unit C from the third software unit D by means of the first software unit A via a communication bus to the hardware unit C that is mounted within the self-service apparatus, identificating the user by contactless reading (NFC) and/or reading of a bank card and/or inputting a phone number (MSISDN) via an interface of the self-service device. At this step, after a bar purchase button is pushed by the user via a GUI interface of the self-service apparatus, the unit C receives a corresponding procedure request for an information regarding availability of the bars from the unit D, and receives, from the unit C, an information regarding numbers of a cell which stores them, a denomination, as well as an amount within the storage dispenser and a required amount of the bar(s) from a specific cell(s). Then, the method comprises a step of confirming that the purchase is possible by processing a user personal data and by sending a request from the third software unit D via the second software unit B to the integration platform of the omnichannel system via the ISO 8583 protocol to the processing center and/or via a request to the automated banking system (ABS) of the provider of financial and/or banking services via the secured communication channel or via the API protocol. The user is identified by means of an automated identification unit being a client identification system that is integrated with one of the providers of financial and/or banking services, the unit comprises user identification based on a contactless reading (NFC) and/or a bank card reading and/or a phone number (MSISDN) inputting. Therewith, the client is enabled to make a selection from at least two possible identifiers.

A next step comprises verifying an availability of the providers of financial and/or banking services connected to the system, where the omnichannel system automatically selects a provider which is licensed to sale the precious metal, receiving a response from external banking systems, and sending a request to form a transactional code to the third software unit D via the second software unit B. If it is not possible to find the required provider in a database of the connected and/or registered providers, and, thus, to perform the client automated identification, the latter will be enabled to select the provider of financial and/or banking services manually on their own from a list on a SHC or ATM screen.

After receipt of the confirmation of the user transactional data, the method comprises a step of forming, by the third software unit D, a purchase authorization code from a user personal account or depositing cash money, or conducting a transaction on-line by means of a payment system card, and transmitting the code to the omnichannel system via the second software unit B.

The execution of the selected transaction comprises a step of calling a certified bar dispensing procedure by the third software unit D via the first software unit A within the hardware unit C. At this step, the monolithic kernel of the unit D fulfills the code and sends address instructions to all units of the module, including calling the procedure, on the unit C, for dispensing the bar(s) from the dispenser.

### BRIEF DESCRIPTION OF THE DRAWINGS

In order to provide more complete understanding of the claimed invention and advantages thereof, the following description provides an explanation of possible exemplary embodiments thereof with a reference to figures of the appended drawings, wherein identical designations denote identical parts, and which illustrate the following:

FIG. 1 illustrates main elements of the module for realizing precious metals and their interconnection with the omnichannel system, the self-service apparatuses and the user;

FIG. 2 illustrates main components of the software unit D and an algorithm for providing an interaction between the same and other units of the module for realizing precious metals;

FIGS. 3A and 3B illustrate main elements of the omnichannel system for providing financial and/or banking services having the service channel for selling the precious metal integrated therein;

FIG. 4 schematically depicts a structure of a physical self-service device in an interactive interaction between the user and the providers of financial and/or banking services, and a digital component of such interaction.

### IMPLEMENTATION OF THE GROUP OF INVENTIONS

The group of inventions is implemented according to the examples given below.

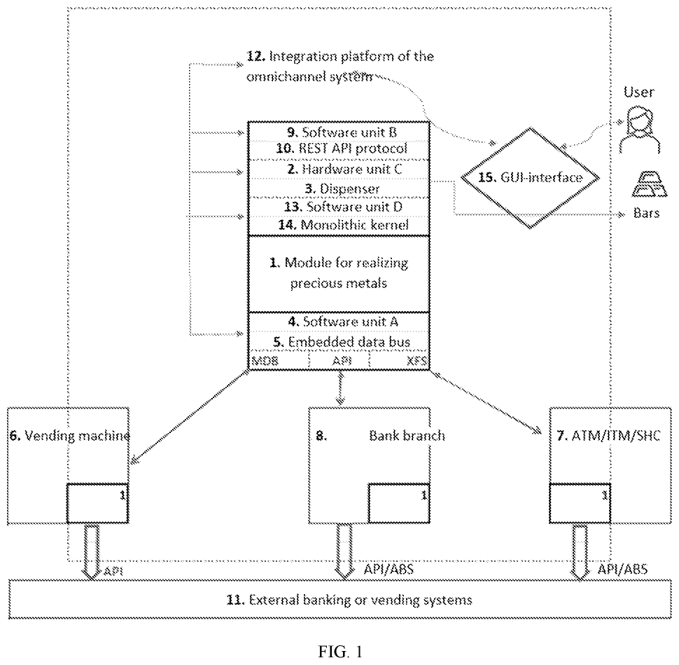

FIG. 1 illustrates a module (1) for selling bank bars packed in corresponding certificates, the module consists of a hardware unit C (2) for dispensing and storing the bars, the unit has a dispenser (3) that stores a plurality of the bars of at least two weight types from 1 g to 1 ounce. The module also consists of a software unit A (4) having a data bus (5) embedded therein, the data bus has protocols/standards implemented therein for connecting the module (1) to any vending machine (6), any ATM or self-service terminal SHC (7), or to any bank branch (8). Therewith, the embedded data bus (5) for connecting the module (1) to the vending machine (6) is a MDB—MultiDrop computer bus, wherein all components are coupled to a single electrical circuit and a process of its addressing determines which device sends an information at any location. Other devices listen to the data to be received by them via the bus (taken from National Automatic Merchandising Association, European Vending Machine Manufacturers Association). In order to connect to the ATM or to the terminal (7), a bus of a CEN/XFS or XFS standard (eXtensions for Financial Services) is used, the bus being intended for a client-server architecture for financial applications on the Microsoft Windows platform being mainly oriented at a software of peripheral devices used in the financial field, where “Extension WOSA for Financial services” or WOSA/XFS. XFS provides a common API for access and management. The module for realizing precious metals is connected to the bank branch (8) via a computer bus corrected by means of API being a set of classes, procedures, functions, structures or constant values which are used by the module for interacting with an ABS software of the bank branch regardless of a manufacturer of the software of the automated banking systems.

The module also consists of a software unit B (9), where a REST API protocol (10) is implemented for interaction with external banking or vending systems (11) by integration of the module (1) by means of an integration platform (12) to an omnichannel system (23).

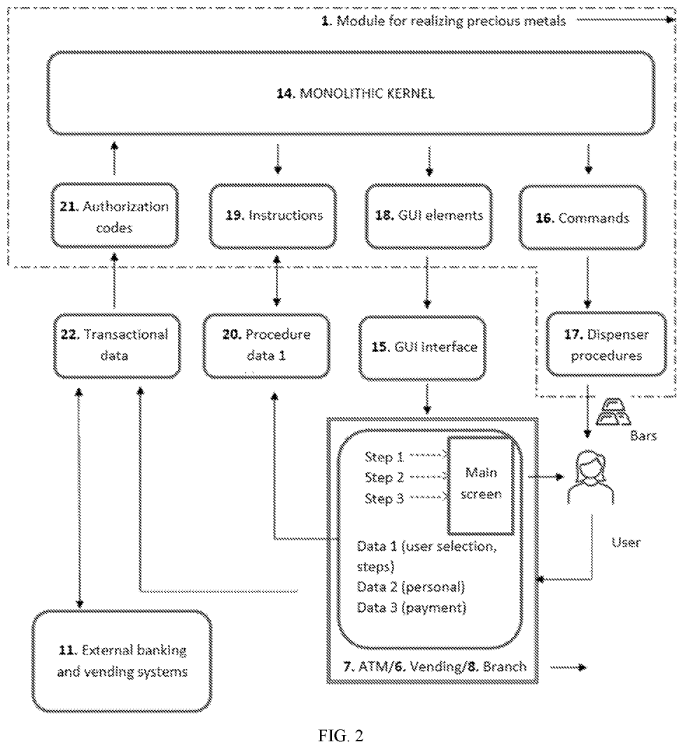

The module also consists of a software unit D (13) having a monolithic kernel (14) that provides an interaction between hardware and software components of the module (1). A client's identification is enabled by a graphical interface (15) of the self-service apparatus, and its elements are also comprised in the module (1). All parts of the monolithic kernel (14) of the software unit D (13) operate within a single address space as illustrated in FIG. 2. Its components are constituent parts of a single program which use general data structures and interact between each other by a direct calling of procedures, such as sending commands (16), performing procedures (17) by the dispenser (3), managing elements (18) of the graphical interface (15), the self-service apparatus (6-8), sending and receiving instructions (19) to process a procedural data (20), processing and forming authorization codes (21) upon receipt of the transactional data (22). Said procedures are constituent parts of the single program, and each of them may call another one and all of them operate in a privileged mode.

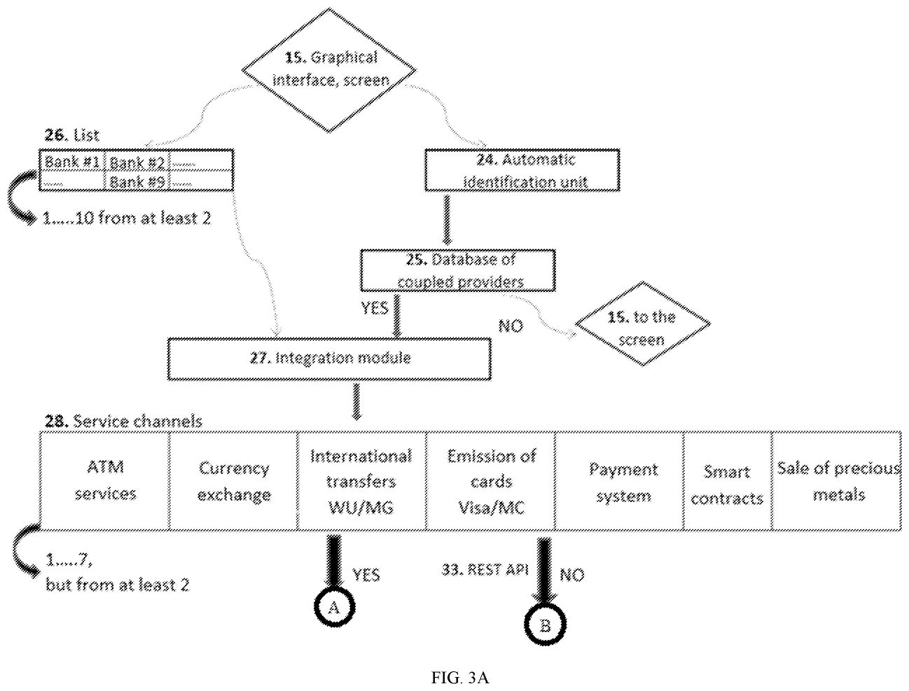

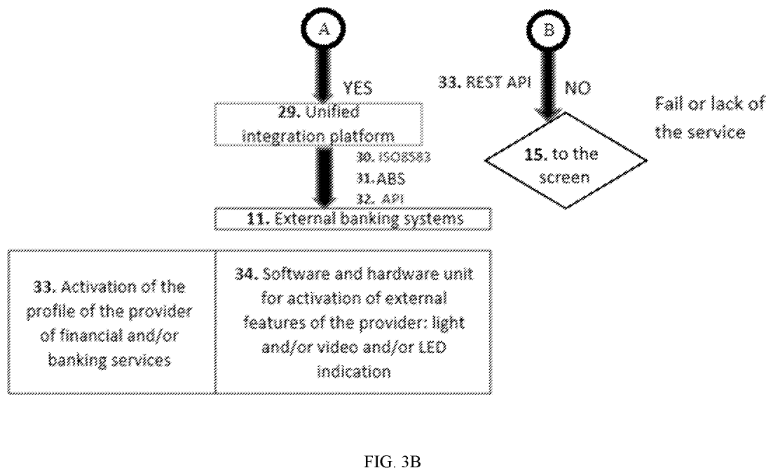

FIGS. 3A and 3B illustrate main elements of the omnichannel system (23) for providing financial and/or banking services having a service channel for selling the precious metal added therein. The omnichannel system that provides integration of the module for realizing precious metals (as disclosed in the Ukrainian patent application a202106003 dated Oct. 26, 2021, as well as in the U.S. patent application Ser. No. 17/660,742 dated Apr. 26, 2022 filed based thereon) and its use for providing an interactive interaction between the user and at least two providers of financial and/or banking services by means of a screen of the graphical interface (15) of the self-service device (6, 7, 8) via a user automatic identification unit (24) that is an identification system integrated with one of the providers of banking and/or financial services and includes user identification based on NFC and/or reading a bank card and/or inputting a phone number MSISDN. The user makes a selection from at least two above-described identification methods on their own, and then the system performs an automatic verification of whether the required provider is present among those coupled and/or registered in a database (25) of the coupled providers and performs the user automatic identification. If it is not possible to perform the automatic identification due to lack of the provider of banking and/or financial services which are licensed to sell the precious metal among those coupled and/or registered in the database (25), the user will select such bank or provider manually from a list (26) on the interface (15) screen.

After the user automatic identification in the automatic identification unit (24) is performed or the user's manual self-selection of the bank from the list (26) on the interface (15) screen is made, the system will turn to a step of selecting, among available service channels (28), a service channel for selling the precious metal among at least two providers of financial and/or banking services which are licensed to sell the precious metal and connected to the integration module (27). Therewith, in case the service among the selected/requested by the user is failed or absent in the selected bank and/or financial services provider, the user will be suggested to return to the main screen (15) or to receive the required service from another provider of banking and/or financial services without returning to the main screen (15), i.e., without re-identification.

Then, the system activates a profile of the provider of banking and/or financial services which is licensed to sale precious metals (33) by means of a direct coupling of a unified integration platform (29) of the integration module (27) to external bank services (11) via ISO 8583 protocol with a processing center (30) and/or via a request to the ABS (31) of the provider of banking and/or financial services via a secured communication channel or via an API protocol (32). Therewith, the unified integration platform (29 interacts with the omnichannel module (27) having the integrated service channel via a REST API protocol (33). In order to facilitate the user's own manual selection of the provider of banking and/or financial services on the main screen of the interface (15) due to their visualization, the system comprises a software and hardware unit (34) that comprises activation of at least two external features of the providers of banking and/or financial services by means of a lighting and/or video and/or LED indication. The external features of the providers of banking and/or financial services are a logo and/or a trademark and/or corporate colors.

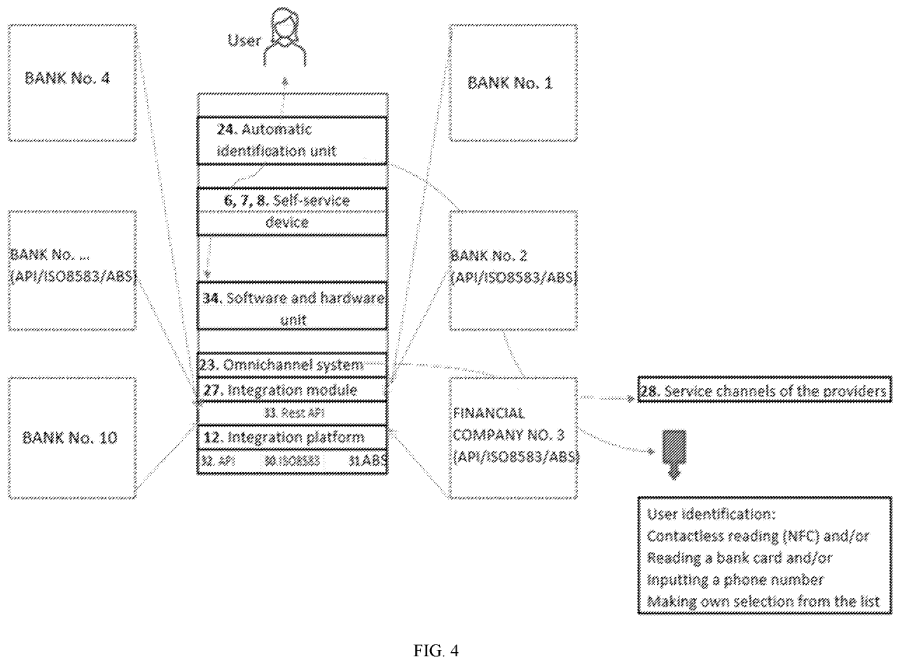

FIG. 4 schematically illustrates the interactive interaction between the user and the providers of financial and/or banking services by means of the physical self-service device (6, 7, 8) that is integrated to the omnichannel system (23) and a digital component of this interaction. According to the described scheme, the physical self-service device is essentially a floor for arrangement of up to ten financial and/or banking services providers therein, such as Bank No. 1, Bank No. 2, Financial company No. 3, Bank No. 4 . . . , Bank No. 10, in a form of their digital presence by means of a software integration of said providers with the omnichannel system (23) via the processing center (30) and/or via the request to the ABS (31) of the provider of banking and/or financial services via the secured communication channel or via the API protocol (32) owing to the internal unified integration platform (29) that interacts with the integration module (27) and, thus, with other elements of the omnichannel system via the REST API protocol (33). The principle of such interaction is based on the omnichannel nature, thereby enabling to save, at various steps of performing operations with the client, its interaction history with the system and to switch the same between the service channels and the bank and/or financial services providers which provide these services. Main service channels (28) which are integrated with the module (27) are ATM services and/or currency exchange services and/or international transfers and/or emission of bank cards and/or payment system services and/or smart contracts, as well as a physical sale of bars of precious metals, owing to the integration of the claimed module (1) into the omnichannel system (23).

The combination of the above-described characteristics enables to connect the claimed module to any bank, financial company or provider server having a license to sale bank gold and to implement the technology of selling bars of precious metals by means of any available settlement via any associated provider of financial and/or banking services. It enables to, easily and reliably, in an automated secured mode, purchase precious metals and to implement wide opportunities of both selecting the provider of this service and paying for a purchase of precious metal bars in any acceptable way being a cash payment, a cashless payment or using digital assets, and without steps of generating random codes and without involvement of additional means.

Therefore, the group of inventions unites the claimed technical solutions by a single inventive concept, while providing their reliability, functionality and modularity.

1. A module for realizing precious metals, comprising of:
a hardware unit C that is equipped with a dispenser for storing and dispensing certified bars, a first software unit A that has an embedded MDB-supporting data bus Plug&Play that is configured to connect the hardware unit to a self-service device that is integrated with an omnichannel system for providing financial and/or banking services, the omnichannel system comprises a client automatic identification means connected to databases of providers of financial and/or banking services, and a unified integration platform for connecting to at least two providers of financial and/or banking services so as to enable selecting and activating those from them that are authorized to sell a precious metal,
a second software unit B to provide an interaction, via a REST API protocol, between the self-service device and the unified integration platform of the omnichannel system, thereby providing a service channel for selling the precious metal via an ISO 8583 protocol with a processing center of the provider of financial and/or banking services and/or via a request to an automated banking system (ABS) of the provider of financial and/or banking services via a secured communication channel or via an API protocol; and
a third software unit D having a monolithic kernel that comprises components that provide an interaction between the software units and the hardware unit within a single address space and that are configured to conduct a financial transaction from a selected payment source.

2. A method for realizing precious metals by means of a module that is integrated with an omnichannel system for providing financial and/or banking services, the method comprising:
a step of requesting for a presence of a certified bar within a dispenser of a hardware unit C from a third software unit D by means of a first software unit A via a communication bus to the hardware unit C that is mounted within a self-service apparatus, identificating a user by contactless reading (NFC) and/or reading of a bank card and/or inputting a phone number (MSISDN) via an interface of the self-service device;
a step of confirming that a purchase is possible by processing a user personal data and by sending a request from the third software unit D via the second software unit B to an integration platform of an omnichannel system via an ISO 8583 protocol to a processing center and/or via a request to an automated banking system (ABS) of a provider of financial and/or banking services via a secured communication channel or via an API protocol;
a step of performing, within the omnichannel system, a verification of an availability of providers of financial and/or banking services, selecting those among them that are licensed to sale a precious metal, receiving a response from external banking systems, and sending a request to form a transactional code to the third software unit D via the second software unit B;
a step of forming, by the third software unit D, a purchase authorization code after receipt of a confirmation of a user transactional data from a personal account or depositing cash money, or conducting a transaction on-line by means of a payment system card, and transmitting the code to the omnichannel system via the second software unit B; and
a step of calling a certified bar dispensing procedure by the third software unit D via the first software unit A within the hardware unit C by transmitting the transaction confirmation code after its receipt from the omnichannel system.
